(19) United States
(12) Patent Application Publication
(10) Pub. No.: US 2005/0242140 A1
(43) Pub. Date: Nov. 3, 2005

(54) Storage apparatus for a bicycle and method for storing

(76) Inventors: Mann Weng Yong, Singapore (SG); Lily Lim, Singapore (SG)

Correspondence Address: NIELDS & LEMACK, 176 EAST MAIN STREET, SUITE 7, WESTBORO, MA, 01581, US

(21) Appl. No.: 10/832,164

(22) Filed: Apr. 26, 2004

(51) Int. Cl. B62J 7/06; A45F 3/04

(52) U.S. Cl. 224/421; 224/426

(57) ABSTRACT

The present invention relates to a storage apparatus in the form of a flexible and foldable sheet whereby the storage sheet is secured to the frame and parts of the bicycle. The storage sheet has pockets for storing items required by a cyclist and attachments such as tools. The storage sheet is compartmentalized with these pockets for the storage of different types of items like accessories, food, tools etc. The pockets and attachments are positioned in a manner for easy retrieval of these stored items by the cyclist during cycling, thereby enabling the cyclist to continue with the cycling. The flexible and foldable storage sheet is secured to the bicycle at strategic locations by employing a 3-contact point system. When not in use, the flexible and foldable storage sheet can be folded neatly, for storage. The foldable storage sheet is also advantageous when the product is put on display for sale or when shipped out to retailers.

### FIELD OF THE INVENTION

The present invention relates to a storage apparatus formed from a flexible and foldable sheet for a bicycle, including a stationary exercise bicycle, whereby said storage sheet is secured to the frame and parts of the bicycle. Said storage sheet contains pockets and attachments positioned in a manner for easy retrieval of items during cycling. Said storage sheet is secured to the bicycle at strategic locations by employing a 3-contact point system. Said storage sheet is compartmentalized to store different types of items like accessories, food, tools etc.

### PRIOR ART & BACKGROUND OF THE INVENTION

Present receptacles for storing items on bicycles include fanny packs, saddle bags and bags mounted on the stem. Each of them serves a specific purpose.

Fanny packs are good for touring on bicycles whereby cyclist's belongings are placed in big bags and fastened to racks purposely mounted at the front and rear wheels.

Bags mounted below the saddle are used primarily for storing tools. The tools are within reach when the bicycle breaks down.

Bags mounted on stems are used for storing food items. On long distance cycling, cyclists need food to sustain their race performances over long period of time. The bags fastened to the bicycle stem are primarily used to store food which makes retrieval of food easy.

There is no storage device fitted on the bike that can store food items and tools in a same location and accessible at the same time during cycling. While some current storage devices can be removed from the bicycle, the removal requires demounting to remove the storage devices. However, even upon removal, the storage device is bulky and cannot be packed away easily.

The present invention allows both food items and tools to be positioned at strategic location making the receptacle accessible to cyclist while cycling. Cyclist can store their food, accessories and tools in one receptacle whereby said receptacle is fastened to the seat post, top tube and stem or handle bar of the bicycle covering the whole length of the top tube. Within the receptacle, said receptacle may be compartmentalised to segregate the different types of items. The storage apparatus can be easily removed from the bicycle and folded up, for easy storage.

### SUMMARY OF THE INVENTION

The present invention relates to a storage apparatus in the form of a flexible and foldable storage sheet whereby said storage sheet is secured to the frame and parts of the bicycle. Said storage sheet contains pockets and attachments positioned in a manner for easy retrieval of items during cycling. Said storage sheet is secured to the bicycle at strategic locations by employing at least a 3-contact point system. Said storage sheet is compartmentalized to store different types of items like accessories, food, tools etc.

The present invention being a flexible and foldable storage sheet attached to the bicycle offers the following advantages:

Securing to the bicycle using 3-contact point system;

Securing to the bicycle using Velcro™ or cable ties also known as zip ties;

Securing to the bicycle using elastic cords;

Zip closures at the top of the receptacle for easy retrieval of items;

Velcro™ closures at the top of the receptacle for easy retrieval of items;

Pockets in the said storage sheet for depositing items like food, tools and equipments;

Reflective swatches sewn to the receptacle for safety in the dark;

Water resistant by using waterproofing material like polyester fabrics;

Light weight; Machine washable;

Non-slapping of luggage in the receptacle during bicycling.

As the storage sheet is flexible and foldable, it can be easily packed when not in used or when put on display at the retail outlet. Warehousing and distribution of the said storage sheet is also easily facilitated.

In the first preferred embodiment, said storage sheet is located above the top tube secured to 3 points of the bicycle namely, stem, top tube and seat post.

The front part of the storage sheet is attached to the stem, the bottom of the storage sheet is attached to the top tube and the back of the receptacle is attached to the seat post. These attachments to the 3 parts of the bicycle constitute the 3-contact point system.

Pockets are located in the said storage sheet facing one another. Separate pockets may exist on the right and left walls of the said storage sheet allowing the said storage sheet to be opened widely exposing all the pockets if it is not secured to the bicycle.

Pockets may also exist in a way that joins the left and right walls of the said storage sheet allowing the said storage sheet to be partially exposed if it is not secured to the bicycle.

The pockets prevent objects stored within in the storage sheet from hitting the top tube of the bicycle, which in turn eliminates clunking noise as the bicycle travels. The pockets also offers easy location of items through use of different types of compartments for different types of items.

Pockets can be varied in dimensions and size, thus can be designed to hold standard gel flask bottles or food items like bars and gel packs.

Extra space in the said storage sheet is to be used to hold tools and equipment for the bicycle.

Said storage sheet can also be fitted with cushioning material that eliminates the equipment and tools hitting the top tube of the bicycle.

Said storage sheet has attachments able to secure the commonly used tools like portable air pump, wrenches or other multi tools.

Said storage sheet is made up of water resistant material to prevent perspiration and rainwater to seep into the receptacle protecting the items in it.

The top opening of the said storage sheet may be left ajar.

Alternatively, the top opening of the said storage sheet may be sealed by any number of ways like using Velcro™ or a double zip. The latter offers a flexible way to open the said storage sheet for easy retrieval of items as well as protection from the elements.

In the second preferred embodiment, said storage sheet is mounted on the top tube of the bicycle secured at 3 points namely the head tube, down tube and the seat tube.

The front part of the storage sheet is attached to the head tube, the front bottom of the storage sheet is attached to the down tube and the back of the storage sheet is attached to the seat tube. These attachments to the 3 parts of the bicycle constitute the 3-contact point system for the second preferred embodiment. To reinforce the attachment of the storage sheet to the bicycle, two fastening devices may be attached beneath the storage sheet secured to the top tube.

Said storage sheet has pockets that are located on the outer left and right side of the storage sheet.

Pockets are designed to fit most items like food bars, gel packs and tools. Said pockets are elastic to hold the items in place and prevent bouncing.

The loose ends of the left and right side of the storage sheet may be secured using Velcro™. In this way, the loose ends will not swing when bicycling.

Attachment loops may be positioned on the inner sides of said storage sheet to secure spare tubes, tires and air pump.

In the third preferred embodiment, said storage sheet is secured to the bicycle using an elastic cord that hooks on one side of the handle bar, go round the seat post and extends to the other side of the handle bar. This embodiment differs from the first embodiment whereby the point of contact is the stem of the bicycle instead of the handle bar. At the seat post, a device is attached to ensure that the elastic cord does not slide. Velcro™ may be used to secure the left and right borders of the storage sheet to the elastic cord. The bottom of the storage sheet is secured to the top tube of the bicycle using Velcro™.

Pockets are located in the storage sheet facing one another.

Attachments loops for tools, spare tubes and tires may be located at the outer walls of the storage sheet.

The triangular shape formed by the elastic cord serves to shield the bicycle frame from the perspiration dripping from the cyclist. However, there is a shortcoming to this embodiment. The receptacle will be shifted when the cyclist attempts to make a turn on the bicycle. However, this embodiment is suitable for installation on stationary exercise bicycles.

In the fourth preferred embodiment, said storage sheet is a combination of the storage sheet of the first embodiment and the storage sheet of the second embodiment.

Said storage sheet e may be secured to the bicycle by a number of methods.

In the first method, Velcro™ may be used to secure the front end of the storage sheet to the stem of the bicycle, the bottom of the storage sheet are fitted with Velcro™ to secure to the top tube of the bicycle and the back of the storage sheet are fitted with Velcro™ to secure to the seat post.

In the second method, zip ties also known as cable ties may be used to secure the said storage sheet. However, this method discourages the removal of the storage sheet. Once secured, the removal would mean to dismemberment of the zip ties.

Said pockets are able to carry a number of items like water bottles, gel packets, food bars, tools and equipment. Pocket openings may be enclosed by using Velcro™. Elastic textile or mesh nets may be used to produce the pockets.

### BRIEF DESCRIPTION OF THE DRAWINGS

Illustrative embodiments of the present invention will now be described, by way of example, with reference to the accompanying drawings, in which:

FIG. 1 illustrates the present invention from the left perspective fastened to the bicycle frame using fastening devices

FIG. 1a illustrates the first preferred embodiment in plan view fastened to the bicycle frame using fastening devices

FIG. 2 illustrates the second preferred embodiment from the left perspective fastened to the bicycle frame using fastening devices

FIG. 3 illustrates the second preferred embodiment from a 3D perspective on the left of the bicycle with pockets and fastening devices.

FIG. 4 illustrates the third preferred embodiment from the left perspective whereby a different method of fastening is employed

FIG. 4a illustrates the third preferred embodiment from a 3D perspective on the left of the bicycle showing the pocket

FIG. 4b illustrates the third preferred embodiment from a 3D perspective on the left of the bicycle with fastening devices around the top tube of the bicycle and the handlebar

FIG. 4c illustrates the third preferred embodiment from a plan perspective

FIG. 5 illustrates the fourth preferred embodiment combining the first and second embodiments

### DETAILED DESCRIPTION OF THE PREFERRED EMBODIMENTS

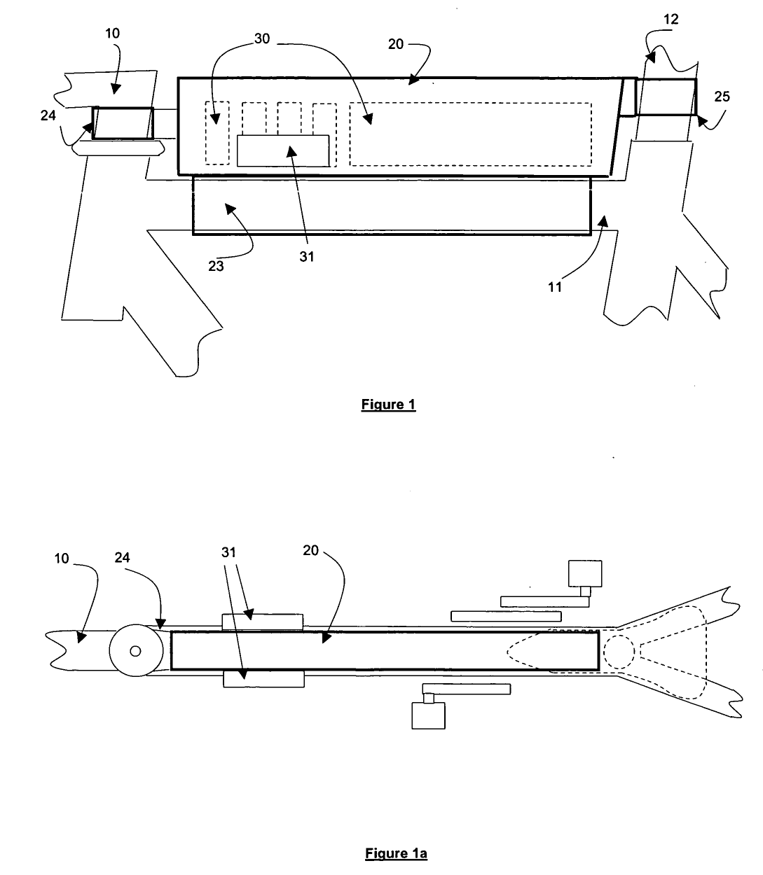

With reference to FIG. 1, the storage apparatus is in the form of a foldable and flexible sheet of material, 20 which is secured to 3 points of the bicycle namely the stem 10, the top tube 11 and the seat post 12.

The foldable and flexible storage sheet is secured by a first fastening device 23 at the top tube 11, the a second fastening device 24 at the seat post 12 and a third fastening device 25 at the stem 10. The fastening devices may be Velcro™ or any other methods of fastening that is able to secure the foldable and flexible sheet 20.

FIG. 1a illustrates the plan view of the first embodiment whereby the said foldable and flexible storage sheet 20 is fastened to the stem 10 with the second fastening device 24.

The inner compartment of the storage sheet 20 contains pockets 30 as denoted by the quad-sided polygons. The pockets 28 may be in different shapes and sizes according to the most commonly carried items by the cyclists. Some probable items are food bars, gel packets, multi-tools, air pump and spare tire tubes.

Attachment loops 31 may also be located at the sides of the storage sheet 20 to maximize the holding capacity. Items like air pumps and spare tubes may be fastened to these attachments at the side of the storage sheet when the storage sheet is securely fastened to the 3 points of the bicycle.

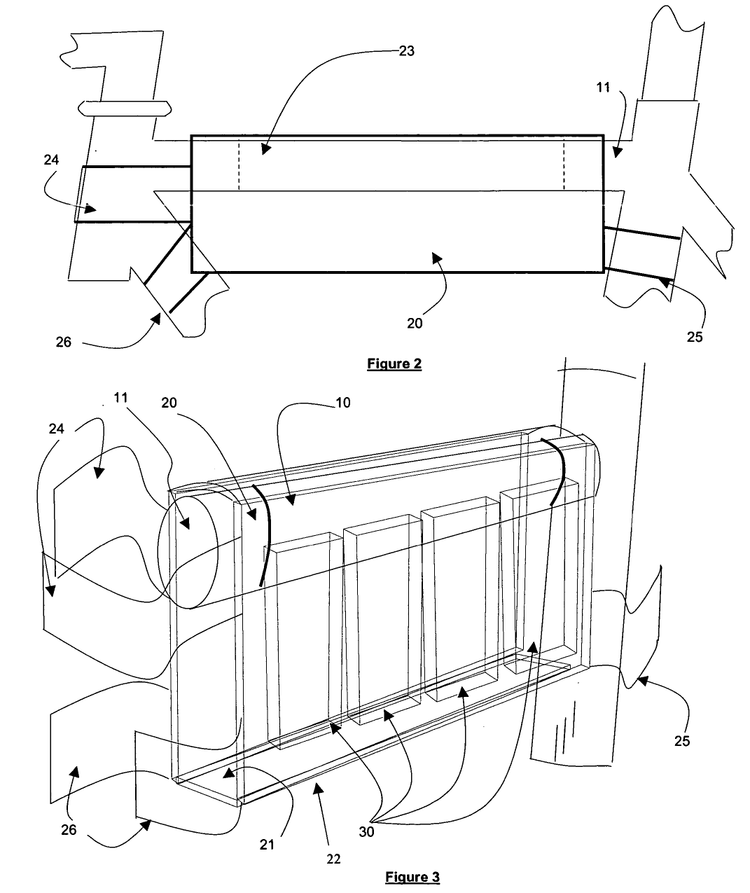

With reference to FIG. 2, storage sheet 20 is straddled on the top tube 11. This embodiment has the advantage of making the bike more stable as the weight of the items is nearer to the ground lowering the center of gravity.

Fastening devices are positioned as shown whereby the second fastening device 24 is secured to the head tube 14, the first fastening device 23 secured to the down tube 15 and the third fastening device 25 secured to the seat tube 13. Extra security may be added beneath the storage sheet with an additional fourth fastening device 26 securing the top tube 11.

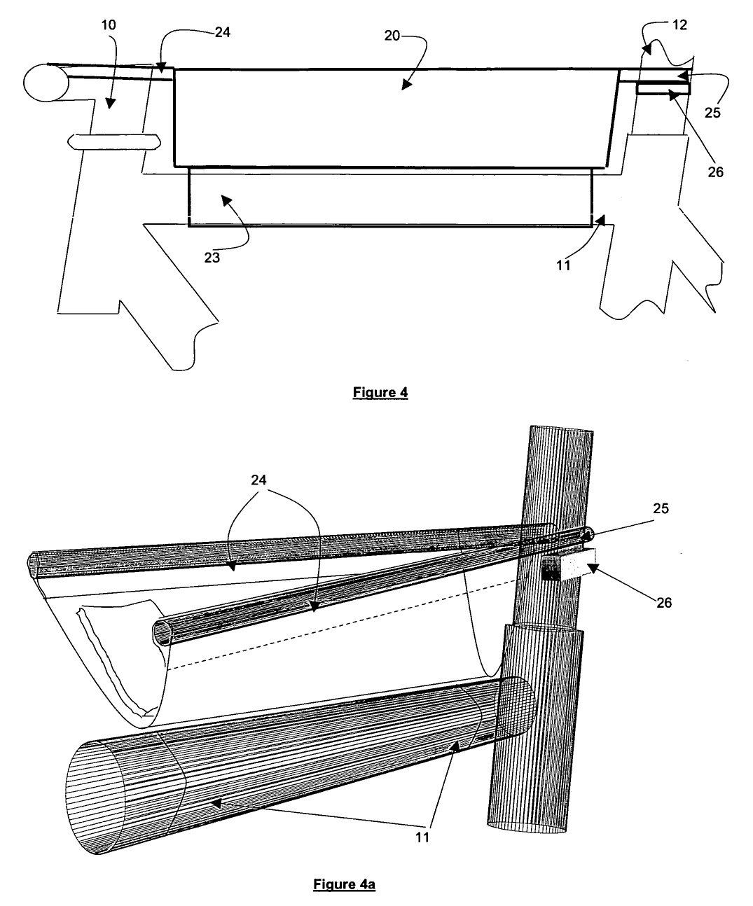

With reference to FIG. 3, said storage sheet 20 is viewed from a side and front perspective. Said storage sheet 20 is straddled over the top tube 11 with overhanging left and right sides having pockets 30.

Fastening devices 24, 23, 25 and 26 are to be secured to the head tube 14, down tube 15, seat tube 13 and the top tube 11 respectively.

The pockets 30 are shown to illustrate the possible location. The number, shape and size of the pockets are not limited to only four. The pockets' openings may be fitted with Velcro™ to make sure the items do not drop from the pockets. Elastic textile may be used to make said pockets.

Velcro™ may be used to secure the two ends 21, 22 of the flexible storage sheet where these two ends meet.

Loop attachments may be positioned along the inner sides of the storage sheet to secure items that are not so commonly needed like tools.

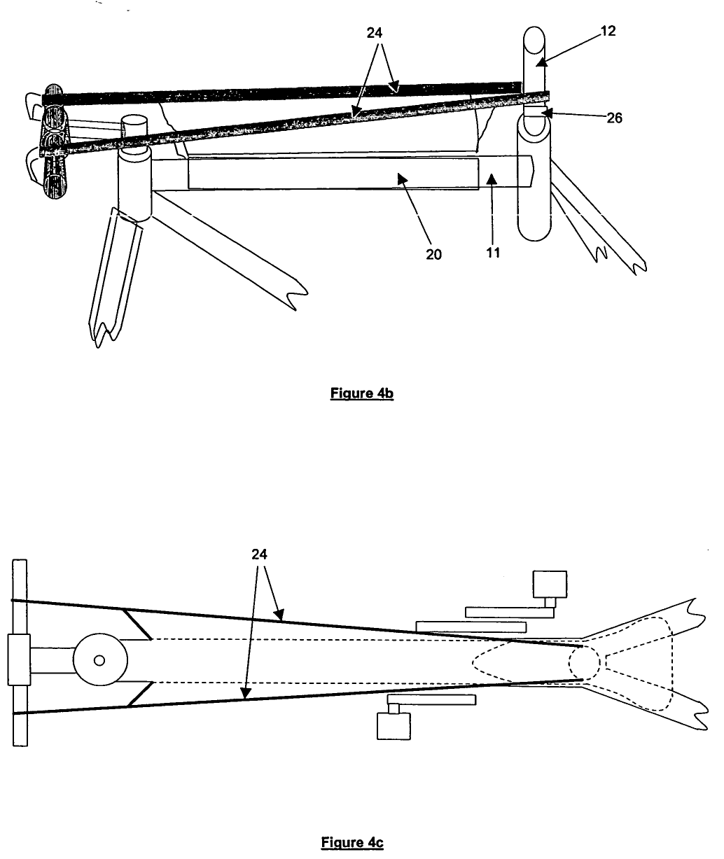

With reference to FIG. 4, said storage sheet 20 is suspended by at least second fastening device 24 in the form of an elastic cord. Said elastic cord 24 may extend from one side of the handle bar 16 round the seat post 12 and extends to the other side of the handle bar 17.

Said elastic cord being the second fastening device 24 may extend from one side of the handle bar 16 to the seat post 12. Let's say the left side of handle bar 16 to the seat post 12 and another elastic cord being the third fastening device 25 may extend from the other side of the handle bar 17 to the seat post 12.

The ends of the said elastic cord are fastened with a fourth fastening means 26 being hooks to secure the cords 24, 25 to the handle bar 16, 17.

To prevent the cord from sliding down the seat post 12, another fastening device 27 is used to fasten the seat post 12. Another fastening device using Velcro™ is located at the top tube 11 only. Other alternative of fastening may also suffice.

With reference to FIG. 4a, the flexible and foldable storage sheet is shown in a 3D cross section perspective.

To secure the storage sheet to the elastic cord, the loose ends 21, 22 are sewn with Velcro™.

The pockets 30 are located within the storage sheet. The opening of the pocket is sewn with Velcro™ to prevent items from displacing.

With reference to FIG. 4b, the said receptacle is shown in a left 3D perspective with the second fastening device 24 as the elastic cord attaching itself to the handle bar 16, 17 and the seat post 12.

The base of the storage sheet 20 is secured to the top tube 11 of the bicycle.

FIG. 4c shows the third embodiment from a plan perspective.

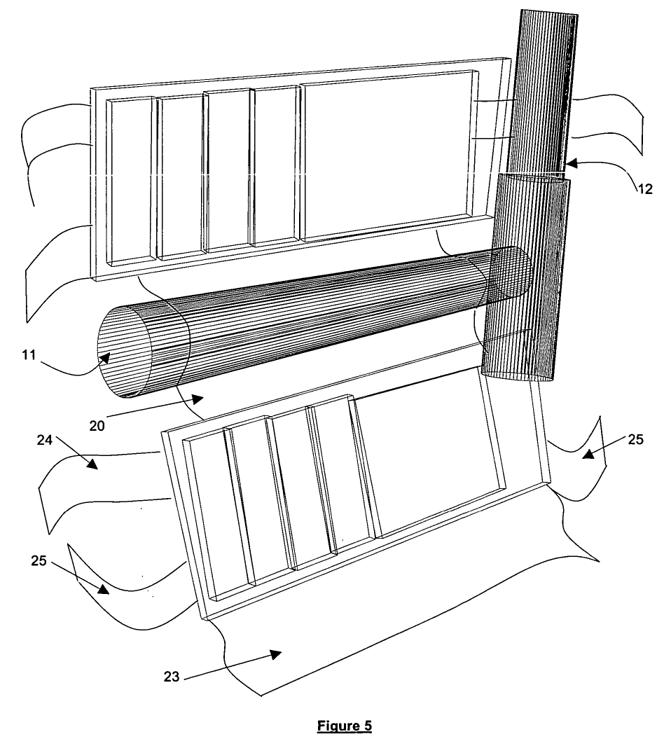

FIG. 5 illustrates the fourth (the preferred) embodiment which is a combination of the first and second embodiments. In the fourth embodiment, the said storage sheet is modified to encompass the first and second embodiments. In the combined storage sheet, the first embodiment being a first storage sheet has the storage sheet 20 above the top tube 11 and the second embodiment being a second storage sheet has the second embodiment positioned below the top tube 11.

With the fourth embodiment, cyclists have the option to choose which configuration they prefer. The flexible and foldable sheet has Velcro™ strips along the first and second ends. Therefore, the second end of the first embodiment and the first end of the second embodiment can be joined using the Velcro™ strips. The fastening locations of the first embodiment include the stem 10, seat post 12 and the top tube 11.

The fastening locations of the second embodiment include the head tube 14, down tube 15, seat tube 13 and the top tube 11. The fourth fastening location, the down tube 15 is optional. Some bicycles do not have the down tube instead these bikes have cable that functions as a down tube; therefore the head tube attachment is used. In a nutshell, at least 3 attachments must be present to secure the receptacle.

The pockets 30 in this fourth embodiment may need to have double openings at the top and bottom because of its flexibility in assuming 2 embodiments. The openings may have to be sewn with Velcro™ to secure the items in their pockets.

At the other side of the flexible and foldable storage sheet, loop attachments 31 may be sewn or adhered to the storage sheet to secure other items like spare tubes and air pump.

Attachment 31 and 32 is secured to the stem 10 when the said storage sheet is above the top tube 11.

Attachment 33 is secured to the seat post 12 when the said storage sheet is above the top tube 11.

Attachment 34 serves as a top cover when the said storage sheet is above the top tube 11.

Attachment 35 is secured to the top tube 11 with the ends fastened to the said storage sheet containing pockets 30.

Attachment 36 is secured to the head tube when the said storage sheet is below the top tube 11.

Attachment 37 is secured to the down tube when the said storage sheet is below the top tube 11.

Attachment 38 is used to for the base of the storage sheet when the storage sheet is below the top tube 11.

Attachment 39 is secured to the seat tube 13 when the storage sheet is below the top tube 11.

The flexible and foldable storage sheet is made from materials which is light weight, water resistant and machine washable. This being the case, the flexible and foldable storage sheet can be easily folded away when not in use or when on display at retail outlets.

The use of the various fastening means would enable the user to mount the storage sheet easily on the bicycle and equally, enjoys the same ease of demounting the storage sheet after using the bicycle.

Modifications within the spirit and scope of the invention may readily be effected by persons skilled in the art. It is to be understood, therefore, that this invention is not limited to the particular embodiments described by way of example hereinabove.

1. A flexible and foldable storage sheet for a bicycle, the bicycle having a frame and other parts such as a handle bar, a stem and a seat post,

2.

3. the storage sheet having a first end and a second end,
the storage sheet having a first fastening means on a length of the storage sheet;
a second fastening means at the first end and a third fastening means at the
second end; and
the storage sheet having one or more compartments;
wherein the storage sheet is secured to the frame lengthwise by the first fastening means and the first and second ends of the sheet further secured to two other parts of the bicycle by the second and third fastening means, the one or more compartments for keeping of items such as accessories and food.

2. A flexible and foldable storage sheet for a bicycle as claimed in claim 1 wherein the storage sheet is suspended on the frame lengthwise and secured to the frame by the first fastening means and further secured to the stem by the second fastening means and to the seat post by the third fastening means.

3. A flexible and foldable storage sheet for a bicycle as claimed in claim 1 wherein the storage sheet is suspended on the frame lengthwise and secured to the down tube of the frame by the first fastening means and further secured to the head tube by the second fastening means and to the seat tube by the third fastening means.

4. A flexible and foldable storage sheet for a bicycle as claimed in any one of claim 2 or claim 3 wherein the storage sheet has a first length and a second length, both lined with Velcro™.

5. A flexible and foldable storage sheet for a bicycle as claimed in any one of claim 2 or claim 3 wherein the storage sheet has attachments on the inner surface for the holding of other equipments.

6. A flexible and foldable storage sheet for a bicycle as claimed in any one of claim 2 or claim 3 wherein the storage sheet has attachments on the outer surface for the holding of other equipments.

7. A fastening means for a flexible and foldable storage sheet for a bicycle as claimed in any one of claim 2 or claim 3 wherein the fastening means is a length of Velcro™.

8. A fastening means for a flexible and foldable storage sheet for a bicycle as claimed in any one of claim 2 or claim 3 wherein the fastening means is a length of cable ties or zip ties.

9. A fastening means for a flexible and foldable storage sheet for a bicycle as claimed in any one of claim 2 or claim 3 wherein the fastening means is a length of elastic cords.

10. A flexible and foldable storage sheet for a bicycle as claimed in any one of claim 2 or claim 3 wherein the storage sheet is removed from the bicycle by unfastening the fastening means when not in use and when used again, the said storage sheet is attached to the bicycle by securing the said storage sheet to the bicycle by the first, second and third fastening means.

11. A flexible and foldable storage sheet for a bicycle as claimed in any one of claim 2 or claim 3 wherein the storage sheet is made of materials which is water resistant, light weight and machine washable.

12. A flexible and foldable storage sheet for a bicycle as claimed in claim 11 wherein the storage sheet is removed from the bicycle by unfastening the fastening means, and folded neatly for easy storage when not in use.

13. A flexible and foldable storage sheet for a bicycle as claimed in anyone of claim 2 or claim 3 wherein the storage sheet can be folded neatly for easy display when put on sale.

14. A method of securing a flexible and foldable storage sheet on a bicycle as claimed in claim 1 comprising the steps:
folding a first storage sheet and closing the first storage sheet for holding and
securing items within the storage sheet using Velcro™ at the first and second lengths
of the storage sheet;
attaching fastening means to the top tube of the frame and two other fastening means
to the stem and seat post and
folding a second storage sheet and closing the second storage sheet for holding
and securing items within the storage sheet using Velcro™ at the first and second lengths
of the second storage sheet;
attaching fastening means to the down tube of the frame and two other fastening
means to the head tube and seat tube.

15. A method of securing a flexible and foldable storage sheet on a bicycle as claimed in claim 1 comprising the steps:
folding a storage sheet and closing the storage sheet for holding and securing
items within the storage sheet using Velcro™ at the first and second lengths of the storage sheet;
attaching fastening means to the top tube of the frame and two other fastening means
to the stem and seat post and

16. A method of securing a flexible and foldable storage sheet on a bicycle as claimed in claim 1 comprising the steps:
folding a storage sheet and closing the storage sheet for holding and securing
items within the storage sheet using Velcro™ at the first and second lengths of the storage sheet;
attaching fastening means to the down tube of the frame and two other fastening
means to the head tube and seat tube.

17. A method for securing a flexible and foldable storage sheet on a bicycle as claimed in any one of claim 13 or claim 14 or claim 15 using fastening means made of Velcro™.

18. A method for securing a flexible and foldable storage sheet on a bicycle as claimed in any one of claim 13 or claim 14 or claim 15 using fastening means are zip tie or cable tie.
